(19) United States
(12) Patent Application Publication
(10) Pub. No.: US 2003/0002870 A1
(43) Pub. Date: Jan. 2, 2003

(54) System for and method of auto focus indications

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/894,380

(22) Filed: Jun. 27, 2001

(51) Int. Cl. G03B 13/30

(52) U.S. Cl. 396/147

(57) ABSTRACT

The present invention includes a system for and method of highlighting portions of the displayed image in a camera which are in focus to the photographer. Included in the highlighted portion are all focused portions of objects within the depth of field.

### BACKGROUND

Cameras, and other image capturing devices, have been used by individuals to record visual images for many years. Earlier cameras used light sensitized emulsion coated on a plate or film onto which a latent image was captured and, once captured and developed, used to create visual images which portrayed the original photographed scene. More recently, digital cameras have become available with their popularity increasing over the last couple of years. Digital cameras typically record captured images as bitmap images in a storage device such as a 3½ inch magnetic disk or similar storage media. These stored images may be processed or modified by a computer user and may be printed out and used accordingly. While the original digital cameras included basic functionality, today's digital cameras include numerous features and in some instances include features which cannot be implemented with conventional film-based cameras. For instance, storage techniques have evolved in such a way that digital cameras may store hundreds of low resolution images. Additionally, digital camera users may select the resolution desired for images being captured and stored. The digital camera user may select images to be recorded in low, medium, or high resolution modes. Since, as the resolution of the captured image increases, the amount of memory dedicated to storing the image also increases, appropriate selection of picture resolution allows faster image capture when only low resolution is required and a corresponding reduction in image processing and storage requirements. Digital photography also allows modifications of captured digital images heretofore unavailable in conventional film photography.

Some types of cameras, both digital and conventional film cameras, include built in automatic focusing. Simple cameras sometimes use Infra Red (IR) detectors to determine range to a subject, others use sonic transducers to provide distance information. In contrast, single lenses reflect (SLR) cameras typically include autofocusing systems which may be classified as contrast measurement or phase matching systems. While phase matching systems are typically used in conventional film cameras, contrast measurement is the preferred method for digital cameras. Thus, most digital cameras achieve a focused image by maximizing the contrast between objects within an image. An object in exact focus is one which is at the precise focusing distance and is dependent on image format (e.g., aspect ratio), lense focal length, aperture size, and focus distance and tolerable circle of confusion for the final image.

The depth of field is an indication of the distance of objects from the focal point of the camera which will appear in focus at a given time. Typically, one-third of the depth of field lies in front of the subject at the precise focusing distance and two-thirds of the depth of field lies behind the subject. One of ordinary skill in the art would appreciate that ultimate print size also effects the depth of field. Typically, for conventional photography, an 8×10 inch print viewed at a distance of 24 inches is used to determine acceptable depths of field guidemarks on lenses. The depth of field is related to a circle of confusion which indicates how large a circle related to an object which is not at the exact focus may become without appearing distorted (e.g., “fuzzy”) to the human eye.

Fully autofocus devices incorporated into prior art cameras may be implemented to adjust depth of field and aperture to bring, for example, a large portion of the viewed image into focus. Alternatively, many prior art cameras include spot focusing which allows the user to identify, to the camera, a specific portion of the image the photographer desires to be focused. One of ordinary skill in the art understands and appreciates these focusing techniques.

All of these prior art devices required the user to determine which portion of the image is being focused by the camera.

### SUMMARY OF THE INVENTION

The present invention is directed to a system of and method for indicating to the photographer the specific portion or portions of the image which are in focus. The method of the present invention includes the steps of receiving a digital representation of an image, examining the digital representation to determine the portions of the image which are in focus and highlighting those focused portions to the photographer. For larger depths of field, far and near focused objects, and objects positioned between the far and near focus objects, may be highlighted, or all focused objects in the digital image may be highlighted.

### BRIEF DESCRIPTION OF THE DRAWINGS

FIG. 1 is a flow diagram of a procedure implemented by a system to determine the focused areas of an image;

FIG. 2 is a flow diagram of a procedure implemented by a system which displays and highlights the focused areas of an image to a user;

FIG. 3 is a hardware block diagram of a camera which incorporates the present invention; and

FIGS. 4A-4C contain sample images, as viewed by the photographer through the viewfinder, which illustrate an embodiment of the present invention.

### DETAILED DESCRIPTION

Generally, the present invention relates to a system for and method of unambiguously highlighting to a photographer the portions of an image contained in the viewfinder of a camera that are in focus. By highlighting the portions of the image which are in focus, confusion and uncertainty are eliminated and expected photographic images will result.

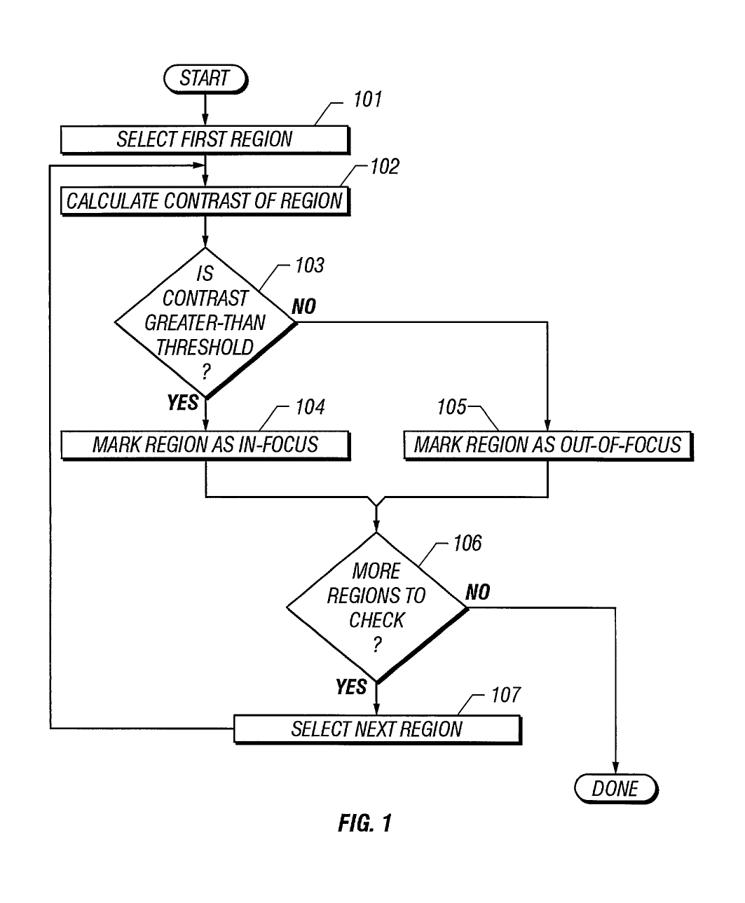

FIG. 1 is a flow diagram of a procedure implemented by a system to determine the focused area of an image. In step 101, a first region of the captured image is selected. In step 102, the first region selected is analyzed to determine the contrast between objects or pixels within the region. As one of ordinary skill in the art appreciates, as the contrast increases so does the focus of the region. In step 103, the contrast of the region calculated in step 102 is compared to a contrast threshold value. If the calculated contrast is greater than the threshold value, the region is considered to be in focus. For regions in which the calculated contrast is greater than the threshold contrast, step 104 marks the region as in focus. For regions in which the calculated contrast is equal to or less than the threshold contrast, step 105 marks the region as out-of-focus. In step 106, a determination is made as to whether additional regions remain to be checked. If additional regions remain, the next region is selected in step 107 and the process flow is returned to step 102. When each region has been checked and each region has been marked as in-focus or out-of-focus, the process is completed.

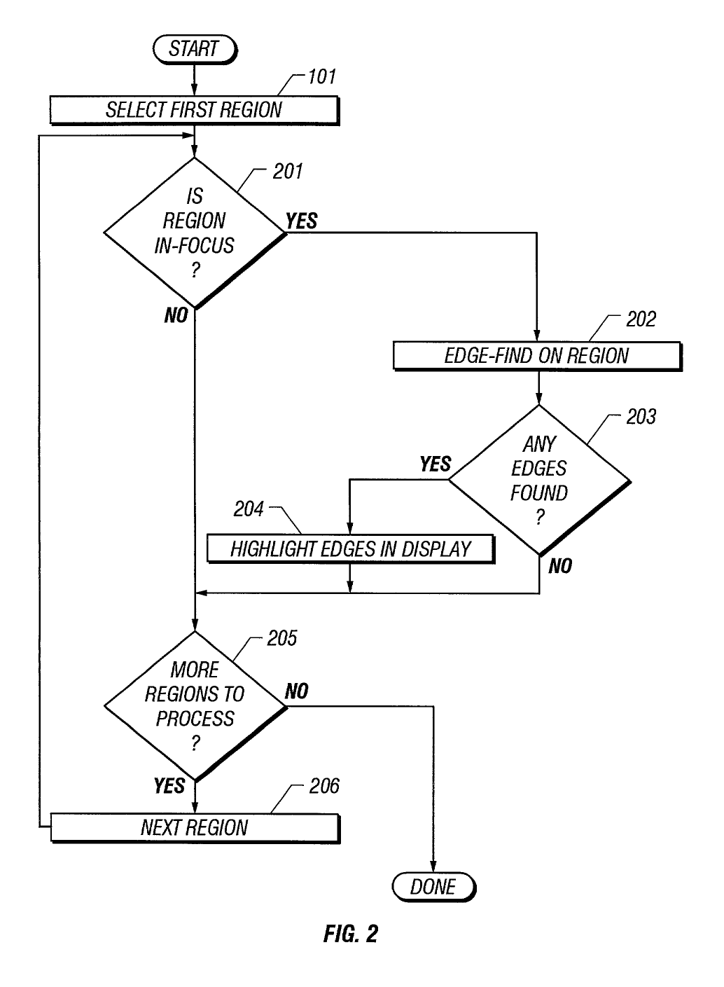

FIG. 2 is a flow diagram of a procedure used by a system to highlight the regions or areas of the image which are in focus. In step 201, a first region is selected for analysis. In step 202, the region is checked to determine if it has been marked as in-focus or out-of-focus. If the region is not marked, flow returns to FIG. 1. If the analyzed region is marked as in-focus, step 203 determines the edge of the region. If edges are found in step 204, then these edges are highlighted in step 205. Highlighting may include blinking the identified portion of the object, reversing its color scheme, enclosing the focused section within a box, or similar highlighting techniques. If edges are not detected in step 204 or, after the detected edges are highlighted in step 205, the procedure continues by determining if additional regions are present which must be checked for in-focus markings. If additional regions are available step 207 selects the next region and the process continues in step 202. If, however, all regions have been checked the procedure is completed.

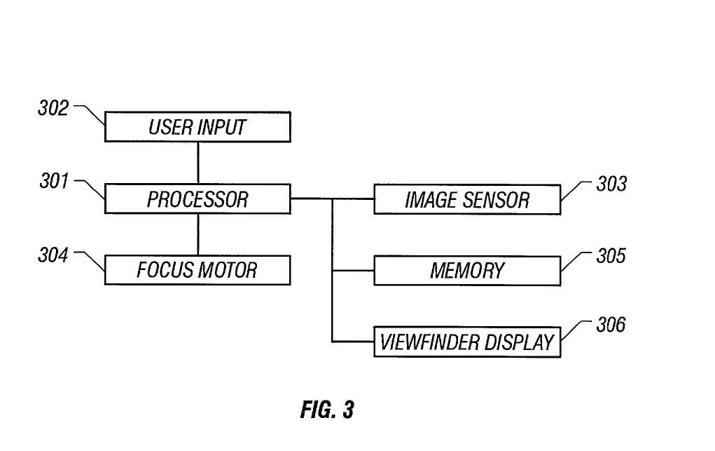

FIG. 3 is a hardware block diagram of a camera which incorporates the present invention. Processor 301 is electrically connected to User Input 302, Image Sensor 303, Focus Motor 304, memory 305 and Viewfinder Display 306.

User Input 302 ensures that the input from the user, such as turning the highlighting feature on or off, is accepted by the system. Image Sensor 303 converts the light image into a suitable signal and/or image data for analysis. Once the image data is available to processor 301, processor 301 may determine areas of the image which are within the near focus ranges, the far focus range, and everything which is in focus between the near focus and the far focus. Focus motor 304 works with process or 301 to present a focused input to the user. Once processor 301 determines which portions of the image are in focus using FIG. 1 and highlights the appropriate portions using FIG. 2, the image, including highlighted portions, is presented on Viewfinder Display 306. When selected by the user, for instance by depressing the shutter, the captured image is recorded, without the associated highlighting, in memory 305.

Note that contrast measurements may be taken during focusing so as to distinguish near focus objects from far focus objects. For example, as focus motor 304 adjusts the lens system from an infinity focus towards a near focus configuration, objects in the far field will increase in contrast until precisely focused, and then decrease in contrast as the lens system continues to be adjusted. The system keeps track of when each object reaches maximum contrast to determine a range to the object based on the focus setting of the lens system. Further, the lens system may be caused to pass through the preferred focus so as to allow mapping of all objects and/or portions of the image, i.e., determine the range to each object based on when the object achieves maximum contrast. Assuming distinct objects will tend to be varying distances from the camera, this technique can also be used to identify the bounds, outline, and extent of image areas representing individual objects. This technique may be used in lieu of or in addition to, edge recognition previously described.

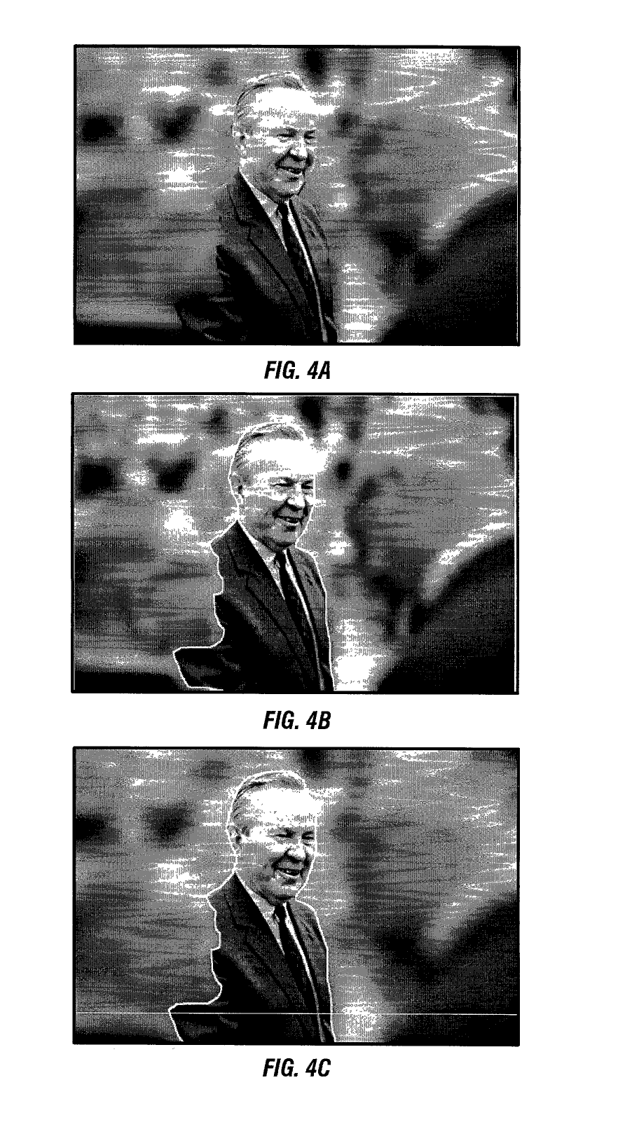

FIG. 4A shows a representative image as the image would be displayed on the viewfinder without benefit of the present invention. While a photographer presented with this image can clearly tell the portion of the image which is in focus, one of ordinary skill in the art would understand other images contain objects which the average photographer cannot be assured are in focus. FIG. 4B shows the image of FIG. 4A after the in-focus section has been highlighted, in this case by outlining, by the present invention. Additional contrast can be obtained by “greying out” or de-emphasizing portions of the image which are not in-focus as determined by contrast measurement as shown in FIG. 4C.

The present invention can also be applied to a manual focusing camera which lacks a focus motor in the lens. For implementation in a manual focusing camera software is included which enables the processor to interface with an encoder included within the lens and determine where in the focus travel the lens currently is positioned. This information is used to determine the portions of the view which are in focus and these portions are highlighted.

What is claimed is:

1. A method of automatically highlighting focused objects within a preview window comprising the steps of:
receiving a digital representation of an image;
determining a near focus distance;
identifying near portions of objects within said image at said near focus distance;
determining a far focus distance;
identifying far portions of objects within said image at said far focus distance; and
highlighting said near portions and said far portions of said objects within said image.

2. The method of claim 1 further including the stop of:
displaying a digital image including said highlighted near and far portions.

3 The method of claim 2 further comprising the step of:
performing said steps of receiving, determining a near focus distance, identifying near portions, determining a far focus distance, identifying far portions, highlight and displaying within a digital camera.

4 The method of claim 1 further comprising the step of:
determining focused portions of objects between said near portions and said far portions; and
highlighting said focused portions.

5. The method of claim 4 further including the step of:
displaying said highlighted focused portions on said digital image.

6. A camera comprising:
an image sensor responsive to a light image projected onto said image sensor for providing image data;
an adjustable focus lens configured to project said light image onto said image sensor;
a controller configured to adjust a focus of said adjustable focus lens and receive said image data from said image sensor, said controller further configured to distinguish portions of said image data that represent focused portions of said light image from portions that are not in focus; and
a display configured to display said image data together with highlighting distinguishing said portions of said image data that represent said focused portions of said light image from said portions that are not in focus.

7. The camera according to claim 6 further comprising a memory storing a contrast evaluation procedure executable by said controller for distinguishing said portions of said image data that represent said focused portions of said light image from said portions that are not in focus.

8. The camera according to claim 6 wherein said image sensor comprises a two-dimensional array of light detectors.

9. The camera according to claim 6 wherein said adjustable focus lens includes a focusing motor connected to adjust a configuration of optical elements of said adjustable focus lens in response to a control signal from said controller.

10. The camera according to claim 6 wherein said controller is configured to determine contrast values of said light image.

11. The camera according to claim 6 wherein said controller is further configured to process said image data for storage in a memory.

12. The camera according to claim 6 wherein said controller implements a lossy compression algorithm on said image data to form compressed image data and stores said compressed image data in a memory.

13. The method of claim 6 further comprising the step of:
disabling said highlighting of said near and said far portions.

14. The method of claim 6 further comprising the steps of:
compressing said digital image to provide compressed image data; and
storing said compressed image data in a memory.

15. The method of claim 6 wherein said determining said near and said far portions is performed from identified edges of objects contained within the digital representation of an image.

16. The method of claim 6 wherein said highlighting comprises blinking said near and far portions of said image in focus.

17. A focus highlighting system comprising:
a processor for highlighting focused portions of an image;
an autofocus mechanism configured to determine portions of an image within focus;
a display configured to display a digital image including highlighting; and
a memory configured to store said digital representation of said image.

18. The focus highlighting system of claim 17 wherein:
said autofocus calculates a near focus distance and determines near portions of objects using said near focus distance.

19. The focus highlighting system of claim 18 wherein:
said autofocus calculates a far focus distance and determines far portions of objects using said far focus distance.

20. The focus highlighting system of claim 19 wherein:
said portions of said image include said near focus portions and said far focus portions.

21. The focus highlighting system of claim 17 wherein said highlighting includes blinking.

22. The focus highlighting of claim 17 further including:
a disable feature which disables highlighting when selected by a user.

23. A camera comprising:
an image sensor;
an image processor configured to determine portions of objects which appear in focus and to highlight said portions; and
a memory configured to store said image captured by said image sensor.

24. The camera according to claim 23 further comprising:
a display connected to display an image captured by said image sensor including said highlighting.

25. The camera according to claim 23 further comprising:
an image compressor configured to perform compression of said corrected image data.

26. The camera according to claim 25 wherein said image compressor implements a lossy image compression algorithm.

27. The camera according to claim 23 further comprising a housing containing said image sensor, display, image processor and memory.

28. The camera according to claim 23 wherein said objects which appear in focus includes objects at different distances from said camera.
